(19) United States
(12) Patent Application Publication
(10) Pub. No.: US 2023/0236792 A1
(43) Pub. Date: Jul. 27, 2023

(54) AUDIO CONFIGURATION SWITCHING IN VIRTUAL REALITY

(71) Applicant: Meta Platforms Technologies, LLC, Menlo Park, CA (US)

(72) Inventors: Meekal Bajaj, San Francisco, CA (US); Gautam Venkatesan, San Jose, CA (US); Peter Aubrey Bartholomew Griess, Dallas, TX (US)

(21) Appl. No.: 17/586,564

(22) Filed: Jan. 27, 2022

(51) Int. Cl. G06F 3/16; G10L 15/02; H04M 7/00

(52) U.S. Cl. CPC G06F 3/165; G10L 15/02; H04M 7/0063; G10L 2015/025

(57) ABSTRACT

Various aspects of the subject technology relate to systems, methods, and machine-readable media for communication a shared artificial reality environment. Various aspects may include receiving an indication of artificial reality location information for a user. Aspects may also include determining an audio configuration for the user based on the artificial reality location information or an application. Aspects may also include determining a switch point for changing the audio configuration for audio between the user and the another user, such as based on the location of the another user. Aspects may also include changing the audio configuration to another audio configuration based on the switch point. Aspects may include outputting audio based on the another audio configuration.

### TECHNICAL FIELD

The present disclosure generally relates to determining and changing audio configurations for users in virtual reality environments, and more particularly to automatic microphone audio channel switching via call sessions for multiplayer games.

### BACKGROUND

Interaction between users of a computing system such as network connected game console environment or a computer generated shared artificial reality environment involves user to user communication for interaction with various types of artificial reality/virtual content, elements, and/or applications in the game console or shared artificial reality environment. Users may desire to communicate with each other in a clear and intuitive manner while playing games or using applications in the game or artificial reality environment. For example, users can communicate in various audio configurations including different audio channels established based on multiuser microphone input and speaker systems. Because there may be multiple audio channels that could depend on specific applications, game consoles, locations, platform, etc. users of the game or artificial reality environment may need to switch between different channels and configurations as they interact with the environment. A microphone/audio switching system that seamlessly determines or changes between different audio configurations for various pairs of users may enhance a multiplayer gaming experience, whether in virtual reality or in a non-virtual reality based gaming environment.

### BRIEF SUMMARY

The subject disclosure provides for systems and methods for communication in a shared artificial reality environment such as switching or changing various audio configurations on a user to user basis as users interact with application environments (e.g., gaming environments) such as by moving locations in the environments. For example, communication in artificial reality or in gaming over the audio configurations can include calls via a system Voice over Internet Protocol (VoIP), a destination VoIP, a mixed VoIP (e.g., combination of system and destination VoIP), a spatialized audio, a non-spatialized audio, etc. The audio configurations may include different audio channels that are potentially initiated when two users are co-located, such as having corresponding user representations that are located in a same particular virtual reality location, experience, game, or application. In such cases, the destination VoIP may be part of an application audio channel that can form part of an in-game app audio system. The system VoIP can be a broader persistent audio channel such as a party audio channel that persists across all apps and destinations that are part of the artificial reality environment. The present disclosure advantageously provides a microphone/audio switcher that can cause switching or changing between audio configurations at switching points, such as when two users are determined to be using the same application and/or are co-located. In this way, the present disclosure enables avoidance of undesirable user audio experiences such as when one audio channel is terminated unexpectedly, double audio is received simultaneously from multiple audio channels, and/or the like. The disclosed audio switcher can be provided according to individual pairs of users so that a user can have a different audio configuration with a second user compared to a third user, for example. Users may control which other users can hear them via the audio switcher. Accordingly, users may experience a better audio experience in artificial reality and/or gaming environments.

According to one embodiment of the present disclosure, a computer-implemented method for communication in a shared artificial reality environment is provided. The method includes receiving an indication of artificial reality location information for a user. The method also includes determining, for the user, an audio configuration based on the artificial reality location information or an application. The method also includes determining, based on a location of another user in the shared artificial reality environment, a switch point for changing the audio configuration for audio between the user and the another user. The method also includes changing, based on the switch point, the audio configuration to another audio configuration. The method includes outputting audio based on the another audio configuration.

According to one embodiment of the present disclosure, a system is provided including a processor and a memory comprising instructions stored thereon, which when executed by the processor, causes the processor to perform a method for communication in a shared artificial reality environment. The method includes receiving an indication of artificial reality location information for a user. The method also includes determining, for the user, an audio configuration based on the artificial reality location information or an application. The method also includes determining, based on a location of another user in the shared artificial reality environment, a switch point for changing the audio configuration for audio between the user and the another user. The method also includes changing, based on the switch point, the audio configuration to another audio configuration. The method includes outputting audio based on the another audio configuration.

According to one embodiment of the present disclosure, a non-transitory computer-readable storage medium is provided including instructions (e.g., stored sequences of instructions) that, when executed by a processor, cause the processor to perform a method for communication in a shared artificial reality environment. The method includes receiving an indication of artificial reality location information for a user. The method also includes determining, for the user, an audio configuration based on the artificial reality location information or an application. The method also includes determining, based on a location of another user in the shared artificial reality environment, a switch point for changing the audio configuration for audio between the user and the another user. The method also includes changing, based on the switch point, the audio configuration to another audio configuration. The method includes outputting audio based on the another audio configuration.

According to one embodiment of the present disclosure, a non-transitory computer-readable storage medium is provided including instructions (e.g., stored sequences of instructions) that, when executed by a processor, cause the processor to perform a method for communication in a shared artificial reality environment. The method includes receiving an indication of artificial reality location information for a user. The method also includes determining, for the user, an audio configuration based on the artificial reality location information or an application. The method also includes determining, based on a location of another user in the shared artificial reality environment, a switch point for changing the audio configuration for audio between the user and the another user. The method also includes receiving, at the switch point and based on user input, a selection of an audio configuration mode. The method also includes determining that the location of the another user and a location of the user in the shared artificial reality environment are within a spatial boundary of a virtual area for availability of another audio configuration. The method also includes changing, based on the switch point, the audio configuration to add another audio configuration. The method includes outputting audio based on the audio configuration and the another audio configuration.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram of a device operating environment with which aspects of the subject technology can be implemented.

FIGS. 2A-2B are diagrams illustrating virtual reality headsets, according to certain aspects of the present disclosure.

FIG. 2C illustrates controllers for interaction with an artificial reality environment, according to certain aspects of the present disclosure.

FIG. 3 is a block diagram illustrating an overview of an environment in which some implementations of the present technology can operate.

FIG. 4 is a block diagram illustrating an example computer system (e.g., representing both client and server) with which aspects of the subject technology can be implemented.

FIG. 5 illustrates an audio configuration model in an artificial reality environment, according to certain aspects of the present disclosure.

FIG. 6 illustrates an audio switcher model in an artificial reality environment, according to certain aspects of the present disclosure.

FIG. 7 is an example flow diagram for communication in a shared artificial reality environment, according to certain aspects of the present disclosure.

FIG. 8 is a block diagram illustrating an example computer system which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

The disclosed system addresses a problem in artificial reality tied to computer technology, namely, the technical problem of improving audio quality within a computer generated gaming or shared artificial reality environment. The disclosed system solves this technical problem by providing a solution also rooted in computer technology, namely, by providing automatic audio channel switching to users of the artificial reality environment such as based on a shared application or location within the environment between pairs of users. The disclosed system also improves the functioning of the computer used to generate the artificial reality environment because it enables the computer to reduce undesirable audio effects and improve audio quality for artificial reality compatible user devices. The present invention is integrated into a practical application of computer based audio in artificial reality environments by providing and automatically switching to high fidelity spatialized audio in pairwise manner when applications or locations are shared. In particular, the disclosed system provides higher quality audio and switching to more desirable audio channels or configurations while users are interactions in in the artificial reality environment, such as playing a game.

Aspects of the present disclosure are directed to creating and administering artificial reality environments. For example, an artificial reality environment may be a shared artificial reality environment, a virtual reality (VR), an augmented reality environment, a mixed reality environment, a hybrid reality environment, a non immersive environment, a semi immersive environment, a fully immersive environment, and/or the like. As used herein, “real-world” objects are non-computer generated and artificial or VR objects are computer generated. For example, a real-world space is a physical space occupying a location outside a computer and a real-world object is a physical object having physical properties outside a computer. For example, an artificial or VR object may be rendered and part of a computer generated artificial environment. The artificial environments may also include collaborative, gaming, working, and/or other environments which include modes for interaction between various people or users in the artificial environments. The artificial environments of the present disclosure may provide elements that enable automatic switching between audio sources or channels, which can advantageously avoid audio issues such as echoes, no audio, lagging audio, and/or the like. For example, audio for the environments described in the present disclosure can be controlled at a channel level. As an example, for each pair of two users of the artificial reality environments, audio can be controlled or maintained separately such that a first user can hear a second user from an application audio channel while hearing a different third user from a phone (platform specific) audio channel.

Embodiments of the disclosed technology may include or be implemented in conjunction with an artificial reality system. Artificial reality, extended reality, or extra reality (collectively “XR”) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some implementations, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real-world after they have passed through a computing system. For example, a tablet with a camera on the back can capture images of the real-world and then display the images on the screen on the opposite side of the tablet from the camera. The tablet can process and adjust or “augment” the images as they pass through the system, such as by adding virtual objects. AR also refers to systems where light entering a user's eye is partially generated by a computing system and partially composes light reflected off objects in the real-world. For example, an AR headset could be shaped as a pair of glasses with a pass-through display, which allows light from the real-world to pass through a waveguide that simultaneously emits light from a projector in the AR headset, allowing the AR headset to present virtual objects intermixed with the real objects the user can see. The AR headset may be a block-light headset with video pass-through. “Artificial reality,” “extra reality,” or “XR,” as used herein, refers to any of VR, AR, MR, or any combination or hybrid thereof.

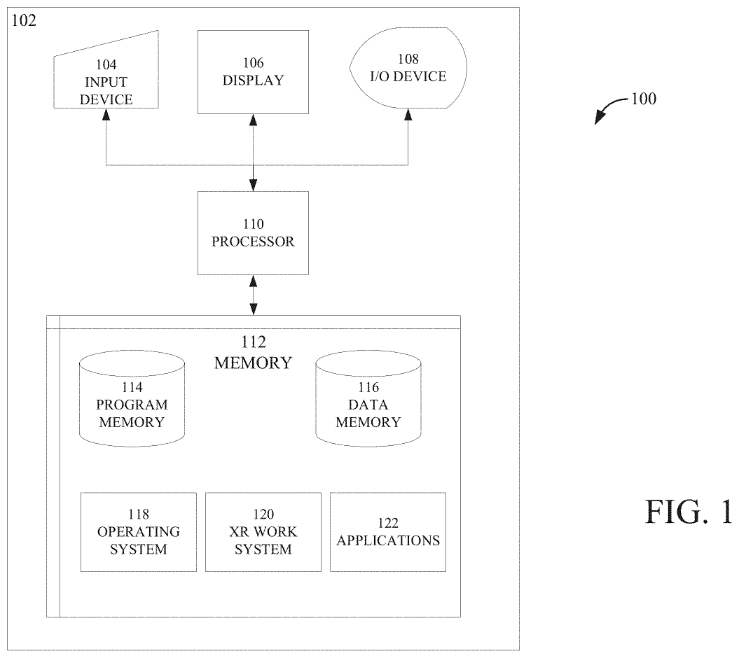

Several implementations are discussed below in more detail in reference to the figures. FIG. 1 is a block diagram of a device operating environment 100 with which aspects of the subject technology can be implemented. The device operating environment can comprise hardware components of a computing system 100 that can create, administer, and provide interaction modes for a shared artificial reality environment (e.g., gaming artificial reality environment) such as for individually control of audio (e.g., switching audio sources) via XR elements and/or real world audio elements. The interaction modes can include different audio sources or channels for each user of the computing system 100. Some of these audio channels may be spatialized or non-spatialized. In various implementations, the computing system 100 can include a single computing device or multiple computing devices 102 that communicate over wired or wireless channels to distribute processing and share input data.

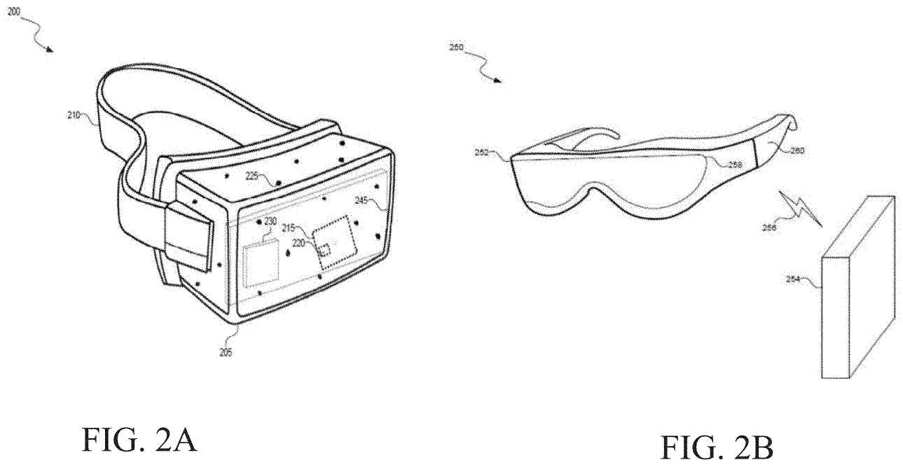

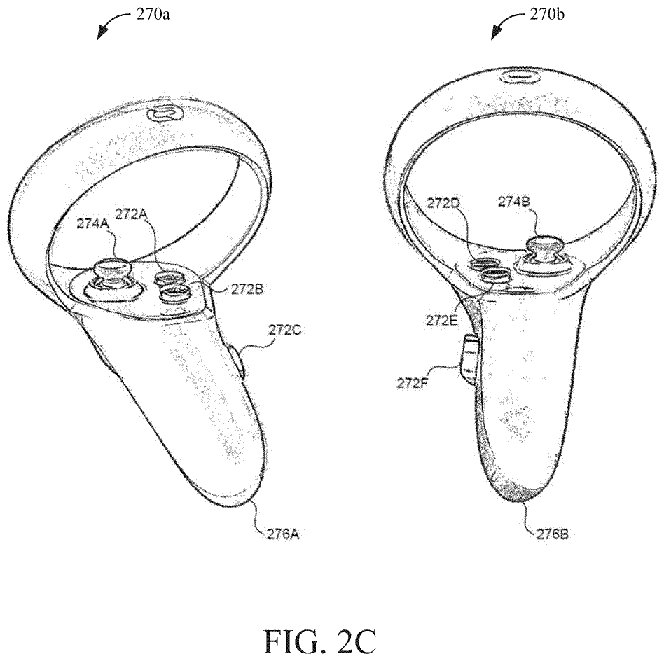

In some implementations, the computing system 100 can include a stand-alone headset capable of providing a computer created or augmented experience for a user without the need for external processing or sensors. In other implementations, the computing system 100 can include multiple computing devices 102 such as a headset and a core processing component (such as a console, mobile device, or server system) where some processing operations are performed on the headset and others are offloaded to the core processing component. Example headsets are described below in relation to FIGS. 2A-2B. In some implementations, position and environment data can be gathered only by sensors incorporated in the headset device, while in other implementations one or more of the non-headset computing devices 102 can include sensor components that can track environment or position data, such as for implementing computer vision functionality. Additionally or alternatively, such sensors can be incorporated as wrist sensors, which can function as a wrist wearable for detecting or determining user input gestures. For example, the sensors may include inertial measurement units (IMUs), eye tracking sensors, electromyography (e.g., for translating neuromuscular signals to specific gestures), time of flight sensors, light/optical sensors, and/or the like to determine the inputs gestures, how user hands/wrists are moving, and/or environment and position data.

The computing system 100 can include one or more processor(s) 110 (e.g., central processing units (CPUs), graphical processing units (GPUs), holographic processing units (HPUs), etc.) The processors 110 can be a single processing unit or multiple processing units in a device or distributed across multiple devices (e.g., distributed across two or more of computing device 102s). The computing system 100 can include one or more input devices 104 that provide input to the processors 110, notifying them of actions. The actions can be mediated by a hardware controller that interprets the signals received from the input device 104 and communicates the information to the processors 110 using a communication protocol. As an example, the hardware controller can translate signals from the input devices 104 to simulate spatialized or non-spatialized audio, such as rendering ambient sounds or other sounds in the vicinity of the user's location for spatialized audio. Each input device 104 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, and/or other user input devices.

The processors 110 can be coupled to other hardware devices, for example, with the use of an internal or external bus, such as a PCI bus, SCSI bus, wireless connection, and/or the like. The processors 110 can communicate with a hardware controller for devices, such as for a display 106. The display 106 can be used to display text and graphics. In some implementations, the display 106 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and/or the like. Other I/O devices 108 can also be coupled to the processor, such as a network chip or card, video chip or card, audio chip or card, USB, firewire or other external device, camera, printer, speakers, CD-ROM drive, DVD drive, disk drive, etc.

The computing system 100 can include a communication device capable of communicating wirelessly or wire-based with other local computing devices 102 or a network node. The communication device can communicate with another device or a server through a network using, for example, TCP/IP protocols. The computing system 100 can utilize the communication device to distribute operations across multiple network devices. For example, the communication device can function as a communication module. The communication device can be configured to transmit or receive audio signals.

The processors 110 can have access to a memory 112, which can be contained on one of the computing devices 102 of computing system 100 or can be distributed across one of the multiple computing devices 102 of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. The memory 112 can include program memory 114 that stores programs and software, such as an operating system 118, XR work system 120, and other application programs 122 (e.g., XR games). The memory 112 can also include data memory 116 that can include information to be provided to the program memory 114 or any element of the computing system 100.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network

PCs, minicomputers, mainframe computers, distributed computing environments that include any of the above systems or devices, and/or the like.

FIGS. 2A-2B are diagrams illustrating virtual reality headsets, according to certain aspects of the present disclosure. FIG. 2A is a diagram of a virtual reality head-mounted display (HMD) 200. The HMD 200 includes a front rigid body 205 and a band 210. The front rigid body 205 includes one or more electronic display elements such as an electronic display 245, an inertial motion unit (IMU) 215, one or more position sensors 220, locators 225, and one or more compute units 230. The position sensors 220, the IMU 215, and compute units 230 may be internal to the HMD 200 and may not be visible to the user. In various implementations, the IMU 215, position sensors 220, and locators 225 can track movement and location of the HMD 200 in the real-world and in a virtual environment in three degrees of freedom (3DoF), six degrees of freedom (6DoF), etc. For example, the locators 225 can emit infrared light beams which create light points on real objects around the HMD 200. As another example, the IMU 215 can include e.g., one or more accelerometers, gyroscopes, magnetometers, other non-camera-based position, force, or orientation sensors, or combinations thereof. One or more cameras (not shown) integrated with the HMD 200 can detect the light points, such as for a computer vision algorithm or module. The compute units 230 in the HMD 200 can use the detected light points to extrapolate position and movement of the HMD 200 as well as to identify the shape and position of the real objects surrounding the HMD 200.

The electronic display 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof. The electronic display 245 can be coupled with an audio component, such as send and receive output from various other users of the XR environment wearing their own XR headsets, for example. The audio component can be configured to host multiple audio channels, sources, or modes.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by the link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc. The frame 260 or another part of the mixed reality HMD 252 may include an audio electronic component such as a speaker. The speaker can output audio from various audio sources, such as a phone call, VoIP session, or other audio channel. The electronic components may be configured to implement audio switching based on user gaming or XR interactions.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real-world.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects. For example, the HMD system 250 can track the motion and position of user's wrist movements as input gestures for performing XR navigation. As an example, the HMD system 250 may include a coordinate system to track the relative positions of various XR objects and elements in a shared artificial reality environment. In this way, the HMD system 250 can render spatially sensitive audio via the audio electronic component. That is, the HMD system 250 can cause users to hear each other in a spatialized manner to simulate talking next or in the vicinity of each other in the real world. For example, if the HMD system 250 determines that two users are co-located next to each other within a threshold vicinity, then the two users may hear each other's audio as spatialized directional audio (e.g., volume of sound based on apparent distance in the shared XR environment) with other ambient sounds from the shared XR environment and other indicators of talking or audio, such as the lips of the corresponding user representations appearing as moving (e.g., lips moving to create visemes corresponding to the output audio via the audio component). The HMD system 250 can also render audio in a non-spatial manner, such as to simulate talking over a radio or phone without any spatial cues such as described for spatialized audio.

FIG. 2C illustrates controllers 270a-270b, which, in some implementations, a user can hold in one or both hands to interact with an artificial reality environment presented by the HMD 200 and/or HMD 250. The controllers 270a-270b can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3DoF or 6DoF). The compute units 230 in the HMD 200 or the core processing component 254 can use this tracking, in combination with IMU and position output, to monitor hand positions and motions of the user. For example, the compute units 230 can use the monitored hand positions to implement navigation and scrolling via the hand positions and motions of the user.

The controllers 270a-270b can also include various buttons (e.g., buttons 272A-F) and/or joysticks (e.g., joysticks 274A-B), which a user can actuate to provide input and interact with objects. As discussed below, controllers 270a-270b can also have tips 276A and 276B, which, when in scribe controller mode, can be used as the tip of a writing implement in the artificial reality environment. In various implementations, the HMD 200 or 250 can also include additional subsystems, such as a hand tracking unit, an eye tracking unit, an audio system, various network components, etc. to monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions. Such camera based hand tracking can be referred to as computer vision, for example. Sensing subsystems of the HMD 200 or 250 can be used to define motion (e.g., user hand/wrist motion) along an axis (e.g., three different axes).

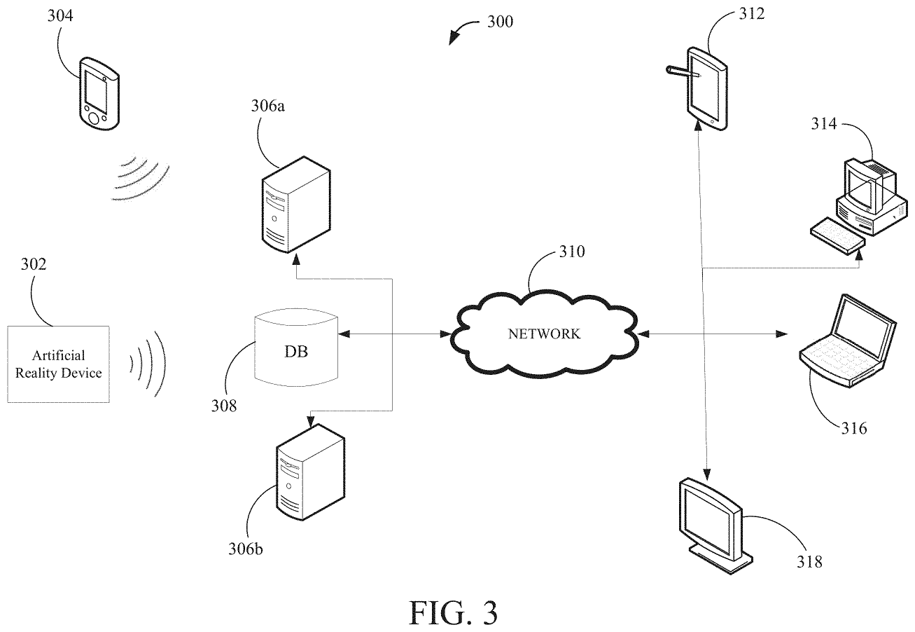

FIG. 3 is a block diagram illustrating an overview of an environment 300 in which some implementations of the disclosed technology can operate. The environment 300 can include one or more client computing devices, such as artificial reality device 302, mobile device 304 tablet 312, personal computer 314, laptop 316, desktop 318, and/or the like. The artificial reality device 302 may be the HMD 200, HMD system 250, a wrist wearable, or some other XR device that is compatible with rendering or interacting with an artificial reality or virtual reality environment. The artificial reality device 302 and mobile device 304 may communicate wirelessly via the network 310. In some implementations, some of the client computing devices can be the HMD 200 or the HMD system 250. The client computing devices can operate in a networked environment using logical connections through network 310 to one or more remote computers, such as a server computing device.

In some implementations, the environment 300 may include a server such as an edge server which receives client requests and coordinates fulfillment of those requests through other servers. The server may include server computing devices 306a-306b, which may logically form a single server. Alternatively, the server computing devices 306a-306b may each be a distributed computing environment encompassing multiple computing devices located at the same or at geographically disparate physical locations. The client computing devices and server computing devices 306a-306b can each act as a server or client to other server/client device(s). The server computing devices 306a-306b can connect to a database 308 or can comprise its own memory. Each server computing devices 306a-306b can correspond to a group of servers, and each of these servers can share a database or can have their own database. The database 308 may logically form a single unit or may be part of a distributed computing environment encompassing multiple computing devices that are located within their corresponding server, located at the same, or located at geographically disparate physical locations.

The memory of the server computing devices 306a-306b or the database 308 can store audio information such VoIP audio channels for one or more applications of a shared XR environment and for a platform hosting the XR environment. The memory or database 308 can be used by the HMD 200 or the HMD system 250 to automatically and selectively mute audio channels for individual pairs of users. For each particular user, the memory of the server computing devices 306a-306b or the database 308 may temporarily or permanently store an indication of each audio channel being used to provide the audio connection with all other users that are associated with the particular user (e.g., friends) or otherwise connected via an audio connection. As an example, the memory or the database 308 may maintain information for the HMD 200, the HMD system 250, or other XR compatible device to provide the audio connection between the particular user with another user via a phone audio channel and with a different user via an application audio channel (e.g., XR audio channel). In this way, when it is determined that a pair of users are located in a same spatial zone, the HMD 200, the HMD system 250, or other XR compatible device can deliver spatialized audio via a spatialized audio channel such as the XR audio channel.

The network 310 can be a local area network (LAN), a wide area network (WAN), a mesh network, a hybrid network, or other wired or wireless networks. The network 310 may be the Internet or some other public or private network. Client computing devices can be connected to network 310 through a network interface, such as by wired or wireless communication. The connections can be any kind of local, wide area, wired, or wireless network, including the network 310 or a separate public or private network. In some implementations, the server computing devices 306a-306b can be used as part of a social network such as implemented via the network 310. The social network can maintain a social graph and perform various actions based on the social graph. A social graph can include a set of nodes (representing social networking system objects, also known as social objects) interconnected by edges (representing interactions, activity, or relatedness). A social networking system object can be a social networking system user, nonperson entity, content item, group, social networking system page, location, application, subject, concept representation or other social networking system object, e.g., a movie, a band, a book, etc.

Content items can be any digital data such as text, images, audio, video, links, webpages, minutia (e.g., indicia provided from a client device such as emotion indicators, status text snippets, location indictors, etc.), or other multi-media. In various implementations, content items can be social network items or parts of social network items, such as posts, likes, mentions, news items, events, shares, comments, messages, other notifications, etc. Subjects and concepts, in the context of a social graph, comprise nodes that represent any person, place, thing, or idea. A social networking system can enable a user to enter and display information related to the user's interests, age/date of birth, location (e.g., longitude/latitude, country, region, city, etc.), education information, life stage, relationship status, name, a model of devices typically used, languages identified as ones the user is familiar with, occupation, contact information, or other demographic or biographical information in the user's profile. Any such information can be represented, in various implementations, by a node or edge between nodes in the social graph.

A social networking system can enable a user to upload or create pictures, videos, documents, songs, or other content items, and can enable a user to create and schedule events. Content items can be represented, in various implementations, by a node or edge between nodes in the social graph. A social networking system can enable a user to perform uploads or create content items, interact with content items or other users, express an interest or opinion, or perform other actions. A social networking system can provide various means to interact with non-user objects within the social networking system. Actions can be represented, in various implementations, by a node or edge between nodes in the social graph. For example, a user can form or join groups, or become a fan of a page or entity within the social networking system. In addition, a user can create, download, view, upload, link to, tag, edit, or play a social networking system object. A user can interact with social networking system objects outside of the context of the social networking system. For example, an article on a news web site might have a “like” button that users can click. In each of these instances, the interaction between the user and the object can be represented by an edge in the social graph connecting the node of the user to the node of the object. As another example, a user can use location detection functionality (such as a GPS receiver on a mobile device) to “check in” to a particular location, and an edge can connect the user's node with the location's node in the social graph.

A social networking system can provide a variety of communication channels to users. For example, a social networking system can enable a user to email, instant message, or text/SMS message, one or more other users. It can enable a user to post a message to the user's wall or profile or another user's wall or profile. It can enable a user to post a message to a group or a fan page. It can enable a user to comment on an image, wall post or other content item created or uploaded by the user or another user. And it can allow users to interact (via their avatar or true-to-life representation) with objects or other avatars in a virtual environment (e.g., in an artificial reality working environment), etc. In some embodiments, a user can post a status message to the user's profile indicating a current event, state of mind, thought, feeling, activity, or any other present-time relevant communication. A social networking system can enable users to communicate both within, and external to, the social networking system. For example, a first user can send a second user a message within the social networking system, an email through the social networking system, an email external to but originating from the social networking system, an instant message within the social networking system, an instant message external to but originating from the social networking system, provide voice or video messaging between users, or provide a virtual environment where users can communicate and interact via avatars or other digital representations of themselves. Further, a first user can comment on the profile page of a second user or can comment on objects associated with a second user, e.g., content items uploaded by the second user.

Social networking systems enable users to associate themselves and establish connections with other users of the social networking system. When two users (e.g., social graph nodes) explicitly establish a social connection in the social networking system, they become “friends” (or, “connections”) within the context of the social networking system. For example, a friend request from a “John Doe” to a “Jane Smith,” which is accepted by “Jane Smith,” is a social connection. The social connection can be an edge in the social graph. Being friends or being within a threshold number of friend edges on the social graph can allow users access to more information about each other than would otherwise be available to unconnected users. For example, being friends can allow a user to view another user's profile, to see another user's friends, or to view pictures of another user. Likewise, becoming friends within a social networking system can allow a user greater access to communicate with another user, e.g., by email (internal and external to the social networking system), instant message, text message, phone, or any other communicative interface. Being friends can allow a user access to view, comment on, download, endorse, or otherwise interact with another user's uploaded content items. Establishing connections, accessing user information, communicating, and interacting within the context of the social networking system can be represented by an edge between the nodes representing two social networking system users.

In addition to explicitly establishing a connection in the social networking system, users with common characteristics can be considered connected (such as a soft or implicit connection) for the purposes of determining social context for use in determining the topic of communications. In some embodiments, users who belong to a common network are considered connected. For example, users who attend a common school, work for a common company, or belong to a common social networking system group can be considered connected. In some embodiments, users with common biographical characteristics are considered connected. For example, the geographic region users were born in or live in, the age of users, the gender of users and the relationship status of users can be used to determine whether users are connected. In some embodiments, users with common interests are considered connected. For example, users' movie preferences, music preferences, political views, religious views, or any other interest can be used to determine whether users are connected. In some embodiments, users who have taken a common action within the social networking system are considered connected. For example, users who endorse or recommend a common object, who comment on a common content item, or who RSVP to a common event can be considered connected. A social networking system can utilize a social graph to determine users who are connected with or are similar to a particular user in order to determine or evaluate the social context between the users. The social networking system can utilize such social context and common attributes to facilitate content distribution systems and content caching systems to predictably select content items for caching in cache appliances associated with specific social network accounts.

In particular embodiments, one or more objects (e.g., content or other types of objects) of a computing system may be associated with one or more privacy settings. The one or more objects may be stored on or otherwise associated with any suitable computing system or application, such as, for example, a social-networking system, a client system, a third-party system, a social-networking application, a messaging application, a photo-sharing application, or any other suitable computing system or application. Although the examples discussed herein are in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identifies a set of users that may access work-experience information on the user-profile page, thus excluding other users from accessing that information.

In particular embodiments, privacy settings for an object may specify a “blocked list” of users or other entities that should not be allowed to access certain information associated with the object. In particular embodiments, the blocked list may include third-party entities. The blocked list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular embodiments, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular concept node corresponding to a particular photo may have a privacy setting specifying that the photo may be accessed only by users tagged in the photo and friends of the users tagged in the photo. In particular embodiments, privacy settings may allow users to opt in to or opt out of having their content, information, or actions stored/logged by the social-networking system or shared with other systems (e.g., a third-party system). Although this disclosure describes using particular privacy settings in a particular manner, this disclosure contemplates using any suitable privacy settings in any suitable manner.

In particular embodiments, privacy settings may be based on one or more nodes or edges of a social graph. A privacy setting may be specified for one or more edges or edge-types of the social graph, or with respect to one or more nodes, or node-types of the social graph. The privacy settings applied to a particular edge connecting two nodes may control whether the relationship between the two entities corresponding to the nodes is visible to other users of the online social network. Similarly, the privacy settings applied to a particular node may control whether the user or concept corresponding to the node is visible to other users of the online social network. As an example and not by way of limitation, a first user may share an object to the social-networking system. The object may be associated with a concept node connected to a user node of the first user by an edge. The first user may specify privacy settings that apply to a particular edge connecting to the concept node of the object, or may specify privacy settings that apply to all edges connecting to the concept node. As another example and not by way of limitation, the first user may share a set of objects of a particular object-type (e.g., a set of images). The first user may specify privacy settings with respect to all objects associated with the first user of that particular object-type as having a particular privacy setting (e.g., specifying that all images posted by the first user are visible only to friends of the first user and/or users tagged in the images).

In particular embodiments, the social-networking system may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular embodiments, the social-networking system may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

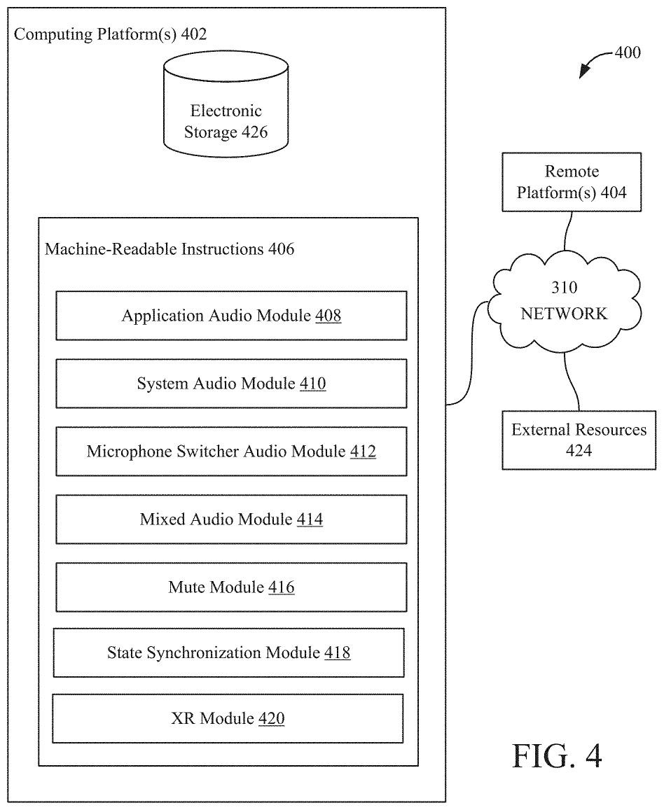

FIG. 4 is a block diagram illustrating an example computer system 400 (e.g., representing both client and server) with which aspects of the subject technology can be implemented. The system 400 may be configured for implementing audio configuration control for XR compatible devices in a shared artificial reality environment (e.g., gaming XR environment), according to certain aspects of the disclosure. The system 400 can implement different audio configurations by providing, selecting, muting etc. various audio channels for each pair of two users of a broader set of users having corresponding user representations in the shared XR environment. The system 400 can avoid occurrences of undesirable audio artifacts or effects such as echoes, feedback, lagged, multiple (e.g., double) audio via the same audio through multiple audio channels, etc. The system 400 advantageously can seamlessly switch between different audio configurations and/or channels depending on user interaction in the artificial reality/XR environment, without such undesirable effects including undesirable switching off audio channels that users desire to remain active (e.g., audible).

For each particular user, the system 400 may selectively mute certain other users from certain audio sources (e.g., channels) in a two person specific manner, such as depending on the respective location and/or interaction of the particular user and another user of the other users. For example, if the particular user and the other user are co-located in the same application in the XR environment, playing the same game, etc., then the system 400 can mute the audio of the other user from a system/party audio channel while switching the audio so that the particular user can hear the other user in the destination/application audio channel instead, such as with greater audio quality. In particular, the system 400 may enable automatic control of audio to avoid conflicting audio such as muting one of the available audio channels to avoid duplicative audio. When the particular user and the other user are co-located in the XR environment, a higher quality audio channel may be used for the particular user to hear the other user in immersive three dimensional surround sound and to hear the ambient noise associated with a sensation of the particular user standing next to the other user.

In some implementations, the system 400 may include one or more computing platforms 402. The computing platform(s) 402 can correspond to a server component of an artificial reality/XR platform, which can be similar to or the same as the server computing devices 306a-306b of FIG. 3 and include the processor 110 of FIG. 1. The computing platform(s) 402 can be configured to control the quality of an audio experience for all users of the computing platform(s) 402 at a pairwise level and based on location information of corresponding user representations in the XR environment of all the users. For example, the computing platform(s) 402 may be configured to execute algorithm(s) to determine when to apply spatialized audio and when to apply non-spatialized audio in the XR environment. In this way, the computing platform(s) 402 may automatically upgrade XR or gaming users to the highest possible level of fidelity for each pair of audio communication with other users based on the respective location of the users. For example, the XR compatible devices (e.g., HMD 200, the HMD system 250) of the remote platforms 404 can receive rich presence information including location information for all user representations in the XR environment from the computing platform(s) 402. The rich presence information can be received from third party applications of the shared XR environment.

The computing platform(s) 402 may be configured to communicate with one or more remote platforms 404 according to a client/server architecture, a peer-to-peer architecture, and/or other architectures. The remote platform(s) 404 may be configured to communicate with other remote platforms via computing platform(s) 402 and/or according to a client/server architecture, a peer-to-peer architecture, and/or other architectures. Users may access the system 400 hosting the shared XR environment via remote platform(s) 404. In this way, the remote platform(s) 404 can be configured to cause output of a version of the shared XR environment for particular user representations corresponding to users using client device(s) of the remote platform(s) 404, such as via the HMD 200, HMD system 250, and/or controllers 270a-270b of FIG. 2C. As an example, the remote platform(s) 404 can access artificial reality content and/or artificial reality applications for use in the shared artificial reality for the corresponding user(s) of the remote platform(s) 404, such as via the external resources 424. The computing platform(s) 402, external resources 424, and remote platform(s) 404 may be in communication and/or mutually accessible via the network 150.

The computing platform(s) 402 may be configured by machine-readable instructions 406. The machine-readable instructions 406 may be executed by the computing platform(s) to implement one or more instruction modules. The instruction modules may include computer program modules. The instruction modules being implemented may include one or more of application audio module 408, system audio module 410, microphone switcher audio module 412, mixed audio module 414, mute module 416, state synchronization module 418, XR module 420, and/or other instruction modules. The computing platform(s) 402 and the remote platform(s) 404 can be configured to apply a VoIP implementation, a client-model, a server drive model, location mechanism, etc.

As discussed herein, the application audio module 408 can be used to determine, select, send, receive, etc. audio configurations in an XR environment for individual users (e.g., for each XR compatible device of the remote platforms(s) 404), including for pairs of user representations/users in the XR/gaming environment. The audio configurations include different audio channels or audio sources that may include multiple users engaged in the respective channels. That is, the respective channels can host an multiparty group call, chat, and/or multiple microphone inputs from different users. The users included in the respective channels can overlap. For example, a particular user in the XR or gaming environment may use their XR compatible or other device to communicate with other associated users via a party audio channel, an application audio channel, and/or the like. In the shared XR environment, some channels such as the application audio channel can be used to render spatialized audio such that when the user representation of the particular user is in the vicinity of a user representation of another user and connected via the application audio channel, the particular user may hear the another user in the virtual world as if they were in each other's vicinity talking in the real world. This spatialized audio effect may be generated based on the particular user and the another user being co-located within an application or virtual area in the shared XR environment (e.g., both rendering the same application or existing in the same virtual space).

In comparison, other channels such as the party audio channel can be non-spatialized, such as audio sources provided by the system audio module 410. For example, the party audio channel from the system audio module 410 can be a VoIP call between multiple users that functions as radio because the party audio channel is not depending on any of the multiple users selecting or using a particular application or multiplayer game or having corresponding user representations be located in the same location of the gaming or XR environment. That is, the party audio channel can connect users independently of what kind of interaction users have with the gaming or XR environment. Users that are not located in the same virtual area, portion, or application of the gaming or XR environment cannot be connected via the application audio channel provided by the application audio module 408, but such users can nonetheless hear each other via the party audio channel from the system audio module 410. In this way, users can maintain some level of audio communication (e.g., nonspatialized VoIP call) via the party audio channel regardless of whether they are engaged in the same game or virtual application.

The microphone switcher audio module 412 can implement an audio or microphone switcher as described herein to advantageously enable users to talk to individual users on a particular channel without having to entirely mute any one audio channel or source for all users that are audibly connected via the any one channel or source. This switching can be performed for each pair of users that are connected via some type of audio connection (e.g., application audio channel, party audio channel, etc.). As an example, when the rich presence (e.g., location) information for the particular user and the other user are received and/or indicate that the particular user and the other user are within a same spatial zone, such as standing or being located next to each other. To determine that the particular user and the other user are in the same vicinity and should be in spatial audio communication via the application audio channel, the microphone switcher audio module 412 may analyze presence information from applications of the XR environment (e.g., provided via the XR environment platform from internal or external application developers). The microphone switcher audio module 412 may use this information to switch pairs of users from one audio source to another audio source, provided that each of the pairs of users have granted microphone access to their gaming or XR compatible device. The microphone switcher audio module 412 can control audio modality for each user of all the users that are in audio communication via an audio source provided by the computing platform(s) 402 or the remote platform(s) 404.

For example, for the particular user, the microphone switcher audio module 412 can control audio communication with each of the other users that the particular user can hear simultaneously via the channels the particular user is connected to. As an example, if the particular user has accessed multiple channels simultaneously such as to talk to a subset of users via the application audio channel and another subset of users via the party audio channel, the microphone switcher audio module 412 can automatically switch audio communication between the application audio channel and the party audio channel for each specific user of the two subsets of users. That is, if the specific user of the subset and the particular user are both in the same audio call and the same application or virtual location in the XR environment, the microphone switcher audio module 412 can switch the individual communication between the specific user and the particular user to the application audio channel without completely terminating the party audio channel for either user once it is determined that both users are in the application or are co-located. In particular, if the specific user and the particular user are in the same spatial zone (e.g., corresponding user representations standing next to each other), the audio communication between this pair of users can be upgraded from a non-spatialized radio call experience to a higher fidelity spatialized application audio experience.

The mixed audio module 414 may enable users of the gaming or XR environment to speak to both users that are party members connected via the party audio channel as well as users in the same current destination such as via spatialized audio via the party audio channel when available. This way, the mixed audio module 414 advantageously can reduce or minimize the time where duplicate audio streams are heard or not audio streams are heard via the applicable audio sources/channels. Moreover, the mixed audio module 414 may enable both VoIP sessions corresponding to the application audio channel and the party audio channel to receive microphone input such as via XR compatible devices of the remote platform(s) 404. The mixed audio module 414 may generate signals to indicate when users (e.g., a pair or more than two users) are co-located or located within the same spatial zone (e.g., corresponding user representations are positioned in each other's vicinity in the shared XR environment). Users may have an option to select mixed audio settings such as exclusive audio capture or shared audio capture of their microphone input. In this way, depending on user input, the mixed audio module 414 can select or implement audio configurations such that only users in the application audio channel can be heard, only users in the party audio channel can be heard, or users in both (or more) channels can be heard.

The mixed audio module 414 can implement a mixed audio configuration that selectively applies audio channels for the particular user, such as all of the aggregate pairs of users formed between the particular user and all the other other users that are in audio communication with the particular user. The mixed audio module 414 can use user identifiers of participants in a call (e.g. VoIP call) of particular audio channels to implement the mixed audio configuration. For example, the mixed audio module 414 may receive an indication of the active user identifiers associated with active users/user representations in the application audio channel and/or the party audio channel. The indication of user identifiers can be sent by the computing platform(s) 402 and/or remote platform(s) 404 such as based on XR applications that gather user identifiers of active participants in the XR applications. When the identifiers change, the XR compatible devices of the remote platform(s) 404 can send an indication of the change in user identifiers to the computing platform(s) 402 such as via a push or pull mechanism. The mixed audio module 414 can operate in conjunction with the application audio module 408 and the system audio module 410 to provide users with an option (e.g., a toggle switch on their XR compatible device) to switch from the mixed audio configuration to an app (e.g., only application audio channel is active) or a call configuration (e.g., only party audio channel is active). For privacy considerations, data sharing with the XR applications can be eliminated or limited so that the XR applications are not informed which user identifiers are present in the party audio channel.

The mute module 416 may use systems calls to support per person muting. For example, the application audio module 408 and the system audio module 410 may each receive microphone audio input from the corresponding client devices of the remote platform(s) 404 that are joined to the application audio channel and/or party audio channel, respectively. Because the application audio module 408 and the system audio module 410 can also receive audio, the mute module 416 can receive a timed signal to ensure muting of any of the available channels at the right time. For example, the mute module 416 can cause the party audio channel to suppress its audio for the pair of the particular user and another user when the particular user and the another user enter the same XR or gaming application or are co-located within the XR environment. To this end, XR applications may provide to the mute module 416 destination or location information of user representations in those XR applications relative to the XR or gaming environment. This information can enable the mute module 416 to mute various pairs of users or user representations based on whether those users/user representations are located or positioned at the same virtual area, spatial zone, or destination in the shared environment. Users are provided an option to consent to or decline giving microphone access to the computing platform(s) 402 that render the shared XR environment. Users are also provided an option to consent to the mute module 416 controlling sending and/or receiving microphone input so that the mute module 416 can selectively mute individual other users in the application audio channel or party audio channel depending on interacting with XR applications or particular virtual areas, such as loading an application, moving to an XR location, moving to a virtual destination with an XR app that the other user is also located at, etc.

The state synchronization module 418 may receive metadata information to synchronize state information for individual pairs of users. For example, the state synchronization module 418 can be notified by particular XR applications that a particular pair of (or more than two) users are playing a game together in the XR environment. The metadata received by the state synchronization module 418 can also be used to determine that the XR destination or virtual area within the XR application supports a destination audio session such as rendered via the application audio channel. For example, the state synchronization module 418 can be used to determine information indicating that the particular pair of users are co-located or interacting together in the XR location such that the application audio channel can be used, initiated, or switched to so that the particular pair of users can hear each other in a high fidelity spatialized audio fashion via the application audio channel.

In addition, the state synchronization module 418 can facilitate multiple users playing the same game together, such as Echo VR, which can be based on the state synchronization module 418 coordinating entry or loading the Echo VR application via the party audio channel. The state synchronization module 418 and the microphone switcher audio module 412 advantageously can maintain multiple audio channels for the particular user but use different channels for specific pairs of users. For example, the party audio channel is not entirely shut down when the particular user and another user both start using the Echo VR application so that the particular user and the another user can use the application audio channel (e.g., be upgraded to an higher quality spatialized audio communication channel) while the particular user can continue to talk to other users via the party audio channel because loading the Echo VR application does not automatically terminate the particular user's participation in the party audio channel. That is, the particular user can remain in all desired channels (e.g., the application audio channel and party audio channel) while talking to specific other users via different audio channels depending on joint XR application interaction (e.g., co-location).

The XR module 420 may be used to render the shared artificial reality environment for remote platform(s) 404 via the computing platform(s) 402, for example. The XR module 420 may also automatically implement different audio configurations without use input, as described herein. As an example, the XR module 420 can deliver spatialized or non-spatialized audio for other user representations that are in the vicinity of the particular user's user representation in the XR environment. Spatialized or non-spatialized audio may be delivered based on the application audio channel and party audio channel, respectively. In this way, the XR module 420 may maintain the party audio channel for all the other users that the particular user desires to be in audio communication with. When the particular user enters the same application or game or becomes co-located in the same vicinity/spatial zone as another user, the particular user and the newly co-located another user can have their audio connection automatically be upgraded from the non-spatialized party audio channel to the higher quality spatialized application channel. Additionally or alternatively, the particular user may have the option to add an audio connection with the another user based on establishing an application audio channel based connection with the another user, such as if the particular user and the another user were not already (e.g., previously) in connection via the party application channel. In this way, the XR module 420 avoids the multiple audio problem such as the particular user hearing the same another user via multiple audio channels or sources.

In some implementations, the computing platform(s) 402, the remote platform(s) 404, and/or the external resources 424 may be operatively linked via one or more electronic communication links. For example, such electronic communication links may be established, at least in part, via the network 310 such as the Internet and/or other networks. It will be appreciated that this is not intended to be limiting, and that the scope of this disclosure includes implementations in which the computing platform(s) 402, the remote platform(s) 404, and/or the external resources 424 may be operatively linked via some other communication media.

A given remote platform 404 may include client computing devices, such as artificial reality device 302, mobile device 304 tablet 312, personal computer 314, laptop 316, and desktop 318, which may each include one or more processors configured to execute computer program modules. The computer program modules may be configured to enable an expert or user associated with the given remote platform 404 to interface with the system 400 and/or external resources 424, and/or provide other functionality attributed herein to remote platform(s) 404. By way of non-limiting example, a given remote platform 404 and/or a given computing platform 402 may include one or more of a server, a desktop computer, a laptop computer, a handheld computer, a tablet computing platform, a NetBook, a Smartphone, a gaming console, and/or other computing platforms. The external resources 424 may include sources of information outside of the system 400, external entities participating with the system 300, and/or other resources. For example, the external resources 424 may include externally designed XR elements and/or XR applications designed by third parties. In some implementations, some or all of the functionality attributed herein to the external resources 424 may be provided by resources included in system 400.

The computing platform(s) 402 may include the electronic storage 426, a processor such as the processors 110, and/or other components. The computing platform(s) 402 may include communication lines, or ports to enable the exchange of information with a network and/or other computing platforms. Illustration of the computing platform(s) 402 in FIG. 4 is not intended to be limiting. The computing platform(s) 402 may include a plurality of hardware, software, and/or firmware components operating together to provide the functionality attributed herein to the computing platform(s) 402. For example, the computing platform(s) 402 may be implemented by a cloud of computing platforms operating together as the computing platform(s) 402.

The electronic storage 426 may comprise non-transitory storage media that electronically stores information. The electronic storage media of the electronic storage 426 may include one or both of system storage that is provided integrally (i.e., substantially non-removable) with computing platform(s) 402 and/or removable storage that is removably connectable to computing platform(s) 402 via, for example, a port (e.g., a USB port, a firewire port, etc.) or a drive (e.g., a disk drive, etc.). The electronic storage 426 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 426 may include one or more virtual storage resources (e.g., cloud storage, a virtual private network, and/or other virtual storage resources). The electronic storage 426 may store software algorithms, information determined by the processor(s) 110, information received from computing platform(s) 402, information received from the remote platform(s) 404, and/or other information that enables the computing platform(s) 402 to function as described herein.

The processor(s) 110 may be configured to provide information processing capabilities in the computing platform(s) 402. As such, the processor(s) 110 may include one or more of a digital processor, an analog processor, a digital circuit designed to process information, an analog circuit designed to process information, a state machine, and/or other mechanisms for electronically processing information. Although the processor(s) 110 is shown in FIG. 1 as a single entity, this is for illustrative purposes only. In some implementations, the processor(s) 110 may include a plurality of processing units. These processing units may be physically located within the same device, or the processor(s) 110 may represent processing functionality of a plurality of devices operating in coordination. Processor(s) 110 may be configured to execute modules 408, 410, 412, 414, 416, 418, 420, and/or other modules. Processor(s) 110 may be configured to execute modules 408, 410, 412, 414, 416, 418, 420, and/or other modules by software; hardware; firmware; some combination of software, hardware, and/or firmware; and/or other mechanisms for configuring processing capabilities on the processor(s) 110. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although the modules 408, 410, 412, 414, 416, 418, and/or 420 are illustrated in FIG. 4 as being implemented within a single processing unit, in implementations in which the processor(s) 110 includes multiple processing units, one or more of the modules 408, 410, 412, 414, 416, 418, and/or 420 may be implemented remotely from the other modules. The description of the functionality provided by the different modules 408, 410, 412, 414, 416, 418, and/or 420 described herein is for illustrative purposes, and is not intended to be limiting, as any of the modules 408, 410, 412, 414, 416, 418, and/or 420 may provide more or less functionality than is described. For example, one or more of the modules 408, 410, 412, 414, 416, 418, and/or 420 may be eliminated, and some or all of its functionality may be provided by other ones of the modules 408, 410, 412, 414, 416, 418, and/or 420. As another example, the processor(s) 110 may be configured to execute one or more additional modules that may perform some or all of the functionality attributed below to one of the modules 408, 410, 412, 414, 416, 418, and/or 420.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

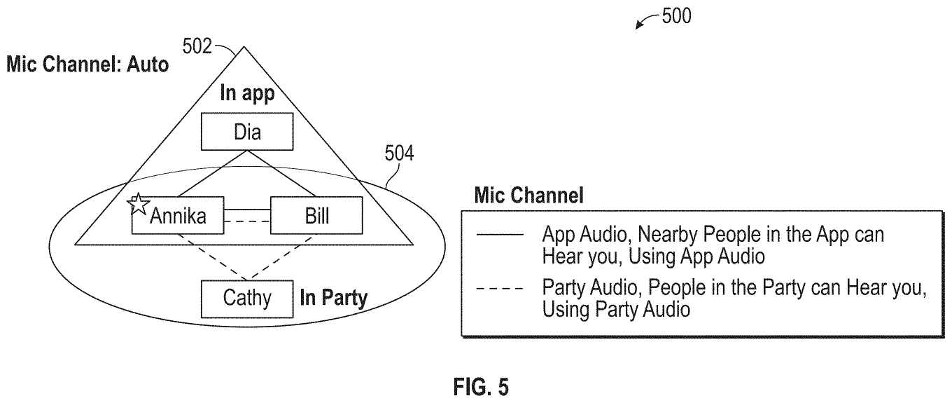

FIG. 5 illustrates an audio configuration model 500 in an artificial reality environment, according to certain aspects of the present disclosure. The audio configuration model 500 can be implemented by an operating system that is part of an XR platform for rendering a shared artificial reality environment. The operating system can execute logic to switch between exclusive and shared audio captures for users of the shared artificial reality environment. The operating system can initiate and maintain a system VoIP session for the XR platform, which can function as a party audio channel. The operating system can host a destination VoIP session, which may be initiated and managed as an application audio channel by internal or external XR or gaming applications. The system VoIP session can be a VoIP call with messenger capabilities that persists across an entire XR session in the XR environment (e.g., persists across use of multiple XR apps). The destination VoIP session may be a VoIP call for a specific XR location, such as if multiple users are in the same virtual bar and connection via the destination VoIP session. The system VoIP session may track all participant user identifiers that are present in the system VoIP session while the destination VoIP session may track all participant user identifiers that are present in the destination VoIP session.

For a particular user in the shared artificial reality environment, the system VoIP session can determine what other user representations (e.g., via the identifiers) are in the same XR location or vicinity of the particular user's user representation location in the XR environment. This location determination can be based on rich presence location information from participating XR applications who have received consent from users engaged in the XR environment. The rich presence information can be reported by XR applications with a valid instance identifier for a system call via Verts and MiVR/Hyperspace using state synchronization. Additionally or alternatively, the particular user's VoIP client can be monitoring and receiving indications of what other users are added to the destination VoIP session corresponding to the particular user's current XR location, such as determining a current roster of users using the same VR application or in the same VR location as the user as well as receiving changes in that roster of participants of the corresponding destination VoIP session. Thus, for example, if the particular user is in communication with another user via the system VoIP session and the another user then joins the same application or location within the XR environment as the particular user, then the particular user's client can mute the system VoIP session based communication with the another user. The another user's client can mirror (e.g., perform the same process) when the another user's client device determines that the particular user and the another user are in the same XR application or location.

As shown in FIG. 5, the audio configuration model 500 includes an application audio channel 502 of the destination VoIP session and a party audio channel 504 of the destination VoIP session. The application audio channel 502 can include users Dia, Annika, and Bill. The party audio channel 504 can include users Annika, Bill, and Cathy. Dia, Annika, and Bill may be in audio communication via the application audio channel 502, which can provide spatialized audio such that nearby people in the corresponding application can hear each other via the application audio channel 502. That is, users having user representations located in the same XR spatial zone or virtual area of the XR environment may hear each other in a spatialized manner, such as including ambient noise and audio quality that simulates hearing someone located in the vicinity. Annika, Bill, and Cathy may be in audio communication via the party audio channel 504, which can provide non-spatialized audio such that users in the party channel can hear each other in a radio type of mechanism regardless of user XR or gaming location. The microphone or audio switcher of the present disclosure can cause change audio channel for individual pairs of users; that is, the switcher can implement audio configurations in a pairwise manner of users.

As an example, Annika and Bill may previously be in connection via the party audio channel 504, but when the operating system or audio switcher determines that Annika and Bill are now in the same XR or gaming spatial zone or location, Annika and Bill's audio configuration can be switched from the party audio channel 504 to the application audio channel 502. This seamless switching may advantageously avoid issues associated with multiple audio channels competing for users' microphone input and avoid audio issues such as audio echoes and unclear or inaudible audio. Moreover, the operating system or audio switcher can enable users to talk to individual other users within their party audio channel 504, their application audio channel 502, or both channels. Also, when users load an XR application, this activity does not automatically terminate the entire party audio channel 504, although certain other users on the party audio channel 504 can be muted if a better audio connection is available on the application audio channel 502. As discussed herein, for users that are co-located or using an XR or gaming application together, the application audio channel 502 may offer a better audio experience by providing immersive spatialized audio that uses direction audio and renders lip movements corresponding to a conversation between co-located users and ambient sounds around the co-located users. In other words, the operating system or audio switcher of the XR platform may apply audio configurations to automatically select which audio channel to use between specific pairs of two people.

This automatic microphone switching function may be selected by users of the XR platform via user input indicative of activating an “auto” feature for XR applications. For the auto feature selected by for a subject user, both users in the application audio channel 502 and the party audio channel 504 can hear while the XR platform is configured for muting audio between nearby users/user representations. Users who are near the subject user in an XR application may sound spatialized and have visemes reflect audio (e.g., via lip movement) while users who are far away from the subject user and only connected via party audio may sound non-spatialized (e.g., as if conversation audio were originating from a longer distance away or without distance/spatial based audio components). Accordingly, for example in FIG. 5, Annika can hear Dia, Bill, and Cathy via the application audio channel 502 and the party audio channel 504, respectively, but the party audio between Annika and Bill can be muted in favor of application audio between Annika and Bill via the application audio channel 502 when Annika and Bill have the same location in the XR or gaming environment. For example, the XR platform can mute call audio of the party audio channel 504 and switch to or initiate call audio via the application audio channel 502 for two particular users having user representations that are located next to each other in the same application based on rich presence information that indicates they are located next to each other. That is, the XR platform may selectively mute audio based on the received location information of the rich presence information.

The location information can generally be received from subject XR applications in a client pull manner so that subject XR applications share data of user representations who are close to a current user's user representation location in the corresponding subject XR application. The location information can be part of rich presence or lobby session data shared by the subject XR applications. When the location information indicate that two users/user representations are next to each other, the XR platform may check if the sharing subject application has microphone access, whether user identifiers in a list of nearby users shared by the subject application match any user identifiers in the party, and selectively mute party audio via the party audio channel 504 between the current user and any nearby users having matching user identifiers. As an example, in FIG. 5, if Annika were the subject user and Bill's user identifier were on the list of nearby users, then the XR platform would mute the party audio between Annika and Bill in favor of the higher fidelity spatialized app audio of the application audio channel 502 once it was verified that Annika and Bill had user representations in the same location, such as via the location information shared by the subject XR applications. Additionally or alternatively, the XR platform can mute party audio between Annika and Bill via the party audio channel 504 as soon as user identifiers indicate that both Annika and Bill loaded or caused their user representations to enter the same application. The XR platform can limit user information being shared for the privacy of users, such as according to user selected settings or a user opt-in feature.

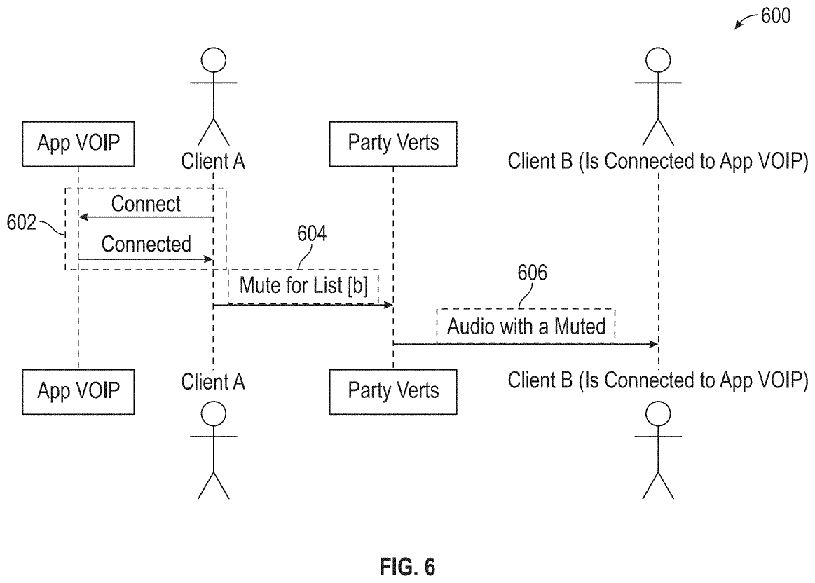

FIG. 6 illustrates an audio switcher model 600 in an artificial reality environment, according to certain aspects of the present disclosure. The audio switcher model 600 can comprise client devices such as gaming or XR compatible devices to manage audio streams. For example, the audio streams can be incoming or outgoing streams. The client devices can be configured to manage outgoing streams such as muting audio channels for audio configurations implemented by an audio or microphone switcher. The audio switcher model 600 may implement a process flow comprising steps 602, 604, 606. At step 602, the client devices may include a client device A that is connected via to an application VoIP call (e.g., application audio channel) such as using an application programming interface (API) to connect to the application VoIP. The API can receive connect requests and indications that a particular user is connecting to the application VoIP call. The API can inform an XR platform that manages the artificial reality environment that the particular user is in an audio session with other users. Moreover, XR applications can call the API each time any user connects or disconnects from their corresponding VoIP session, such as via a list of remote clients that are connected via an audio stack. At step 604, the client device A may mute the client device A's audio stream for a system VoIP session (e.g., party audio channel Verts) based on mapped user identifiers.

Such mapped user identifiers may be stored in a data structure such as the list “b” of remote client being used by the XR platform or system VoIP call (e.g., party audio channel) to mute mapped identifiers if they are on the application VoIP call. In other words, the API can apply a selective mute functionality. For the application VoIP call, a party client can update the muted user list on Verts for the local client (e.g., the client device A). If the particular user selected a mixed audio configuration (e.g., always using system/party VoIP session and using/upgrading to application/destination VoIP session if it is available), then the muted list “b” can be cleared. At step 606, audio for other clients (e.g., client B) that are on the muted list can have their audio configuration set such that they are connected to application VoIP but not system VoIP. As an example, the user representations associated with client A and client B may be co-located or using the same XR application such that the audio switcher model 600 switches client A and client B′s connection from system VoIP to application VoIP when it is determined (or an indication is received) that the client A and B user representations have entered the same application and/or are co-located.

The XR platform can determine what other clients are connected to a subject client on each XR or gaming application used by the subject client, such as based on state synchronization. A state sync API can inform the XR platform when the subject client has connected to a VoIP session in a subject XR application, which may or may not coincide with destination in the subject application. For example, a poker application can call this state sync API when the user representation of the subject client enters a specific poker room and connects to the destination VoIP session for that room. Similarly, shellEnv can call the state sync API when a user representation uses a copresent home and connects to verts or rsys data channel(s).

For example, shellENV can be used to set a location identifier for a party, such as a current home location in the artificial reality environment. The state sync can be based on application identifier, VoIP session identifier, and/or local user microphone state.

For example, when client B receives the user of client A's status, client B may verify whether user A's application identifier and VoIP identifier client B's identifiers. If client A's microphone status indicates a selection of the mixed audio configuration, then client B may mute client A. Clients may have the option to switch from the mixed audio configuration to only one of the system VoIP session or destination VoIP session, for example. The implementation of audio configuration switching and mixed audio configuration selected can be performed as a server side function or a client sided function. As discussed herein, the audio switcher model 600 can seamlessly address and reduce or avoid conflicting audio streams arising from a subset of users that are connected via the system VoIP call and co-located in an app that offers its own destination/application VoIP call. Moreover, the audio switcher model 600 can provide an advantageous timing mechanism to enable users (e.g., in a pairwise manner for each pair of users) to be automatically upgraded (or via user input such as user interface checkbox or toggle) to a higher fidelity spatialized destination VoIP channel if available.

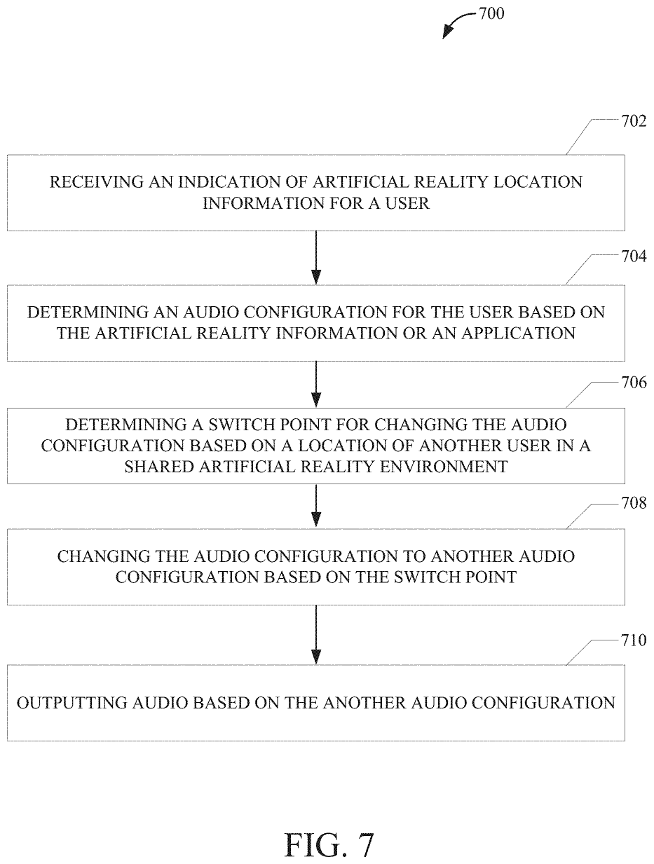

FIG. 7 illustrates an example flow diagram (e.g., process 700) for communication in a shared artificial reality environment in a shared artificial reality environment, according to certain aspects of the disclosure. For explanatory purposes, the example process 700 is described herein with reference to one or more of the figures above. Further for explanatory purposes, the steps of the example process 700 are described herein as occurring in serial, or linearly. However, multiple instances of the example process 700 may occur in parallel. For purposes of explanation of the subject technology, the process 700 will be discussed in reference to one or more of the figures above.

At step 702, an indication of artificial reality location information for a user may be received. According to an aspect, receiving the indication of the artificial reality location information comprises receiving user presence data indicative of a virtual area within the shared artificial reality environment. At step 704, an audio configuration based on the artificial reality location information or an application may be determined. According to an aspect, determining the audio configuration comprises determining at least one of: a party audio channel, an application audio channel, an audio channel, or an audio source, and wherein the audio configuration corresponds to an audio quality. At step 706, a switch point for changing the audio configuration for audio between the user and the another user may be determined. According to an aspect, determining the switch point comprises determining that the user and the another user have both selected a same artificial reality application rendered via the shared artificial reality environment. According to an aspect, determining the switching point comprises switching the audio configuration to a first audio channel, a second audio channel, or a combination of the first audio channel and the second audio channel.

At step 708, the audio configuration may be changed to another audio configuration based on the switch point. According to an aspect, changing the audio configuration to the another audio configuration comprises establishing an application destination Voice over Internet Protocol (VoIP) session of the another audio configuration. For example, the audio configuration comprises an artificial reality platform system VoIP session. According to an aspect, changing the audio configuration to the another audio configuration comprises muting audio from the another user via the audio configuration based on a user identifier of the another user. At step 710, audio may be output based on the another audio configuration. According to an aspect, outputting the another audio configuration comprises applying, via a first microphone input of the user and a second microphone input of the another user, a spatialization of audio between the user and the another user when they are co-located in the shared artificial reality environment.

According to an aspect, the process 700 may further include receiving, at the switch point and based on user input, a selection of an audio configuration mode. According to an aspect, the process 700 may further include determining that the location of the another user and a location of the user in the shared artificial reality environment are within a spatial boundary of a virtual area for availability of another audio configuration. For example, changing the audio configuration comprises changing, based on the audio configuration mode, the audio configuration to add the another audio configuration. For example, outputting audio comprises outputting audio based on the audio configuration and the another audio configuration According to an aspect, the process 700 may further include rendering directional audio and lip movements according to visemes in an application party channel of the another audio configuration.

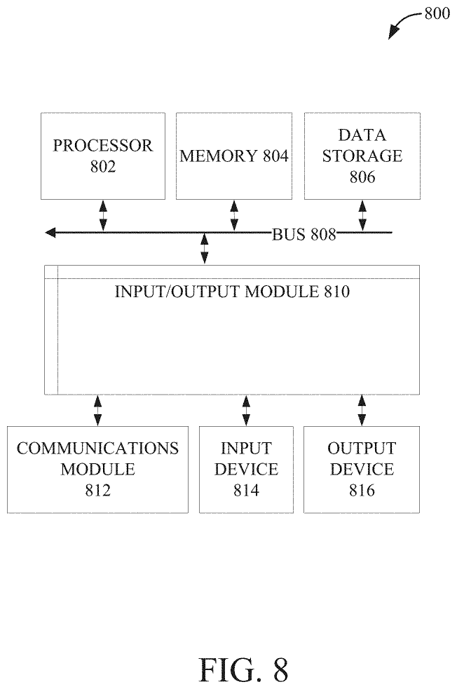

FIG. 8 is a block diagram illustrating an exemplary computer system 800 with which aspects of the subject technology can be implemented. In certain aspects, the computer system 800 may be implemented using hardware or a combination of software and hardware, either in a dedicated server, integrated into another entity, or distributed across multiple entities.

The computer system 800 (e.g., server and/or client) includes a bus 808 or other communication mechanism for communicating information, and a processor 802 coupled with the bus 808 for processing information. By way of example, the computer system 800 may be implemented with one or more processors 802. Each of the one or more processors 802 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

The computer system 800 can include, in addition to hardware, code that creates an execution environment for the computer program in question, e.g., code that constitutes processor firmware, a protocol stack, a database management system, an operating system, or a combination of one or more of them stored in an included memory 804, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 808 for storing information and instructions to be executed by processor 802. The processor 802 and the memory 804 can be supplemented by, or incorporated in, special purpose logic circuitry.

The instructions may be stored in the memory 804 and implemented in one or more computer program products, i.e., one or more modules of computer program instructions encoded on a computer-readable medium for execution by, or to control the operation of, the computer system 800, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 804 may also be used for storing temporary variable or other intermediate information during execution of instructions to be executed by the processor 802.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

The computer system 800 further includes a data storage device 806 such as a magnetic disk or optical disk, coupled to bus 808 for storing information and instructions. The computer system 800 may be coupled via input/output module 810 to various devices. The input/output module 810 can be any input/output module. Exemplary input/output modules 810 include data ports such as USB ports. The input/output module 810 is configured to connect to a communications module 812. Exemplary communications modules 812 include networking interface cards, such as Ethernet cards and modems. In certain aspects, the input/output module 810 is configured to connect to a plurality of devices, such as an input device 814 and/or an output device 816. Exemplary input devices 814 include a keyboard and a pointing device, e.g., a mouse or a trackball, by which a user can provide input to the computer system 800. Other kinds of input devices can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 816 include display devices such as an LCD (liquid crystal display) monitor, for displaying information to the user.

According to one aspect of the present disclosure, the above-described systems can be implemented using a computer system 800 in response to the processor 802 executing one or more sequences of one or more instructions contained in the memory 804. Such instructions may be read into memory 804 from another machine-readable medium, such as data storage device 806. Execution of the sequences of instructions contained in the main memory 804 causes the processor 802 to perform the process steps described herein. One or more processors in a multi-processing arrangement may also be employed to execute the sequences of instructions contained in the memory 804. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

The computer system 800 can include clients and servers. A client and server are generally remote from each other and typically interact through a communication network. The relationship of client and server arises by virtue of computer programs running on the respective computers and having a client-server relationship to each other. The computer system 800 can be, for example, and without limitation, a desktop computer, laptop computer, or tablet computer. The computer system 800 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to the processor 802 for execution. Such a medium may take many forms, including, but not limited to, non-volatile media, volatile media, and transmission media. Non-volatile media include, for example, optical or magnetic disks, such as the data storage device 806. Volatile media include dynamic memory, such as the memory 804. Transmission media include coaxial cables, copper wire, and fiber optics, including the wires that comprise the bus 808. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 800 reads XR data and provides an artificial reality, information may be read from the XR data and stored in a memory device, such as the memory 804. Additionally, data from the memory 804 servers accessed via a network, the bus 808, or the data storage 806 may be read and loaded into the memory 804. Although data is described as being found in the memory 804, it will be understood that data does not have to be stored in the memory 1004 and may be stored in other memory accessible to the processor 1002 or distributed among several media, such as the data storage 1006.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method for communication in a shared artificial reality environment, the method comprising:
receiving an indication of artificial reality location information for a user;
determining, for the user, an audio configuration based on the artificial reality location information or an application;
determining, based on a location of another user in the shared artificial reality environment, a switch point for changing the audio configuration for audio between the user and the another user;
changing, based on the switch point, the audio configuration to another audio configuration; and
outputting audio based on the another audio configuration.

2. The computer-implemented method of claim 1, wherein receiving the indication of the artificial reality location information comprises receiving user presence data indicative of a virtual area within the shared artificial reality environment.

3. The computer-implemented method of claim 1, wherein determining the audio configuration comprises determining at least one of: a party audio channel, an application audio channel, an audio channel, or an audio source, and wherein the audio configuration corresponds to an audio quality.

4. The computer-implemented method of claim 1, wherein determining the switch point comprises determining that the user and the another user have both selected a same artificial reality application rendered via the shared artificial reality environment.

5. The computer-implemented method of claim 1, wherein determining the switching point comprises switching the audio configuration to a first audio channel, a second audio channel, or a combination of the first audio channel and the second audio channel.

6. The computer-implemented method of claim 1, wherein changing the audio configuration to the another audio configuration comprises establishing an application destination Voice over Internet Protocol (VoIP) session of the another audio configuration, wherein the audio configuration comprises an artificial reality platform system VoIP session.

7. The computer-implemented method of claim 1, wherein changing the audio configuration to the another audio configuration comprises muting audio from the another user via the audio configuration based on a user identifier of the another user.

8. The computer-implemented method of claim 1, wherein outputting the another audio configuration comprises applying, via a first microphone input of the user and a second microphone input of the another user, a spatialization of audio between the user and the another user when they are co-located in the shared artificial reality environment.

9. The computer-implemented method of claim 1, further comprising:
receiving, at the switch point and based on user input, a selection of an audio configuration mode;
determining that the location of the another user and a location of the user in the shared artificial reality environment are within a spatial boundary of a virtual area for availability of another audio configuration; and
wherein changing the audio configuration comprises changing, based on the audio configuration mode, the audio configuration to add the another audio configuration and outputting audio comprises outputting audio based on the audio configuration and the another audio configuration.

10. The computer-implemented method of claim 1, further comprising rendering directional audio and lip movements according to visemes in an application party channel of the another audio configuration.

11. A system for navigating through a shared artificial reality environment, comprising:
one or more processors; and
a memory comprising instructions stored thereon, which when executed by the one or more processors, causes the one or more processors to perform:
receiving an indication of artificial reality location information for a user;
determining, for the user, an audio configuration based on the artificial reality location information or an application;
determining, based on a location of another user in the shared artificial reality environment, a switch point for changing the audio configuration for audio between the user and the another user;
determining that the location of the another user and a location of the user in the shared artificial reality environment are within a spatial boundary of a virtual area for availability of another audio configuration;
changing, based on the switch point, the audio configuration to the another audio configuration; and
outputting audio based on the another audio configuration.

12. The system of claim 11, wherein the instructions that cause the one or more processors to perform receiving the indication of the artificial reality location information cause the one or more processors to perform receiving user presence data indicative of a virtual area within the shared artificial reality environment.

13. The system of claim 11, wherein the instructions that cause the one or more processors to perform determining the audio configuration cause the one or more processors to perform determining at least one of: a party audio channel, an application audio channel, an audio channel, or an audio source, and wherein the audio configuration corresponds to an audio quality.

14. The system of claim 11, wherein the instructions that cause the one or more processors to perform determining the switch point cause the one or more processors to perform determining that the user and the another user have both selected a same artificial reality application rendered via the shared artificial reality environment.

15. The system of claim 11, wherein the instructions that cause the one or more processors to perform determining the switching point cause the one or more processors to perform switching the audio configuration to a first audio channel, a second audio channel, or a combination of the first audio channel and the second audio channel.

16. The system of claim 11, wherein the instructions that cause the one or more processors to perform changing the audio configuration to the another audio configuration cause the one or more processors to perform establishing an application destination Voice over Internet Protocol (VoIP) session of the another audio configuration, wherein the audio configuration comprises an artificial reality platform system VoIP session.

17. The system of claim 11, wherein the instructions that cause the one or more processors to perform changing the audio configuration to the another audio configuration cause the one or more processors to perform muting audio from the another user via the audio configuration based on a user identifier of the another user.

18. The system of claim 11, wherein the instructions that cause the one or more processors to perform outputting the another audio configuration comprises applying, via a first microphone input of the user and a second microphone input of the another user, a spatialization of audio between the user and the another user when they are co-located in the shared artificial reality environment.

19. The system of claim 11, further comprising stored sequences of instructions, which when executed by the one or more processors, cause the one or more processors to perform:
receiving, at the switch point and based on user input, a selection of an audio configuration mode;
rendering directional audio and lip movements according to visemes in an application party channel of the another audio configuration; and
wherein changing the audio configuration comprises changing, based on the audio configuration mode, the audio configuration to add the another audio configuration and outputting audio comprises outputting audio based on the audio configuration and the another audio configuration.

20. A non-transitory computer-readable storage medium comprising instructions stored thereon, which when executed by one or more processors, cause the one or more processors to perform operations for navigating through a shared artificial reality environment, comprising:
receiving an indication of artificial reality location information for a user;
determining, for the user, an audio configuration based on the artificial reality location information or an application;
determining, based on a location of another user in the shared artificial reality environment, a switch point for changing the audio configuration for audio between the user and the another user;
receiving, at the switch point and based on user input, a selection of an audio configuration mode;
determining that the location of the another user and a location of the user in the shared artificial reality environment are within a spatial boundary of a virtual area for availability of another audio configuration;
changing, based on the audio configuration mode, the audio configuration to add the another audio configuration; and
outputting audio based on the audio configuration and the another audio configuration.
